(19) United States
(12) Patent Application Publication
(10) Pub. No.: US 2004/0136536 A1
(43) Pub. Date: Jul. 15, 2004

(54) Method for recording for distributing and reproducing information recorded on data carriers

(76) Inventor: Valentin Alexandrovich Michtchenko, Str Minsk (BY)

Correspondence Address: BROOKS KUSHMAN P.C., 1000 TOWN CENTER, TWENTY-SECOND FLOOR, SOUTHFIELD, MI, 48075, US

(21) Appl. No.: 10/478,092

(22) PCT Filed: May 18, 2001
(86) PCT No.: PCT/BY01/00007

(51) Int. Cl. H04L 9/00

(52) U.S. Cl. 380/277

(57) ABSTRACT

The invention relates to the means for protection of information and can be used in crypto systems for encoding and decoding of information stored and distributed on compact disks. The method for recording of initial information characterized in that main encrypting information is processed in such a manner, as a result of which two independent parts of information are formed: an informative part and an accessory part, each of which separately can not reproduce the initial information even in its separate parts. An accessory part of information is recorded on the disk. The informative part is encoded by individual keys of the user recorded on an additional carrier with a processor, in which the algorithm of encoding with individual keys of the user is implemented. Disks with accessory information may be distributed broadly. Therefore, the method provides full protection from unauthorized duplication, which makes no sense in this case.

### THECHNICAL FIELD

The invention relates to the means for protection of information from unauthorized access and can be used in crypto systems for encoding and decoding of information stored and distributed on compact disks and other carriers, in particular for digital recording and reproducing of audio and video information.

The systems for protection of the recorded information by using the method of encoding and subsequent decoding at readout or reproducing are known. In this case different systems of encoding are used. One of the best known cryptosystems with public keys is the RSA system described in U.S. Pat. No. 4,405,829, entitled “Cryptographic Communications System and Method”, which issued Sep. 20, 1983, in the names of Rivest, Shamir, and Adleman. This system uses a one-side function, i.e. a discrete involution.

The drawback of these systems is a small length of a key which allows to perform decoding in acceptable time limits. On the other side, at the increase of a key length the speed of encoding becomes unacceptable for real-time reproducing.

A cryptographic algorithm MZ4 [WO 00/56004, Mischenko et al.] is the algorithm for functioning of theoretically stable systems with a very large degree of randomization (10⁹ per each symbol of the encrypted text), which allows to ensure statistically independent code towards the initial text. This feature allows to have stationary keys in symmetric systems. Nevertheless this method cannot be quite applied for the purposes of protection of recorded information, since the size of the encrypted text is essentially increased.

A method for encoding [WO 00/65767, Mischenko et al.], is known which allows to transform any machine text (any file) into two encrypted files (the residual file or core and flags), each of which has no meaning, unlike the existing encoding algorithms. The characteristic feature of such representation is that one of files (the core file) can have a small size (selected by the user). Unlike the hash-function operation, here the initial text (file) can be restored from a residual file (core) with the help of another file (flags).

According to this method transformation in each cycle is performed in such a manner, as a result of which are formed a message (Cᵢ) transformed in the given cycle of transformation, which message is smaller in the length then the initial message or equal to it, and an accessory information for the given cycle (Fᵢ):

the number (n) of transformation cycles of the initial message is selected from a preset criterion (for example, the size of the finally transformed message).

The method further consists in forming an encrypted message consisting of two parts, one of which contains the finally transformed message (Cₙ) that is smaller in the length than the initial message, and the second part contains a set of accessory information (F={F₁, F₂, . . . , Fₙ}−flags).

This method of encoding allows both parts of the encrypted message to be independent. In this case the initial text cannot be restored by using any of these parts separately.

Nevertheless this method is not quite applicable for mass duplicating and public distribution of information since requires installation on one carrier of data for the both encrypted parts. Besides, even at arrangement of encrypted parts on different carriers, it is enough to decrypt one carrier for manufacturing and duplicating copies of the encrypted data.

Methods and systems for recording and reproducing audio and video information are known. The method that comprises recording of the main encrypted information and the accessory information on the carriers in the form of a protective code sequence is disclosed in U.S. Pat. No. 6,209,092. The system for recording and reproducing comprises a system for recording an encrypted signal on a data carrier and a reproducing system.

However, this method has all the aforementioned drawbacks and allows decryption, while the carriers can be faked up.

The aim of the invention consists in providing a safe method allowing to protect information recorded on carriers, in particular on compact disks, from unauthorized copying.

The set aim is realized in the following manner.

The method for recording of the initial information with protection against copying comprises the following operations, their sequence and regimes:

performing the main encoding of information in such a manner, as a result of which two independent parts are formed: an informative part and an accessory part, each of which separately can not reproduce the initial information even in its separate parts;

recording an accessory part of information and the keys of the main encoding on the primary data carrier;

distribution of the primary data carrier to any user;

additional encoding of the informative part (core) by individual keys of the user recorded on an additional carrier. The said carrier is a processor, in which the algorithm of encoding with individual keys of the user is implemented,

recording the additionally encrypted informative part of information on an additional (secondary, supplemental) carrier, which afterwards interacts with the reproducing device for the initial information (i.e. player), and which after encoding has at his output the informative part of information encrypted by the individual keys of the user. Thus, one encrypted part of information is additionally ciphered by an individual key recorded on a smart card by the encoding algorithm and cannot be read by any other user.

The method is further characterized by that the main encoding is performed in such a manner that the size of the informative part is made substantially smaller than the size of the accessory part. At the same time the accessory part is made comparable in size or a little bit larger than initial information.

The method for restoration of the initial information for reproducing comprises:

The interaction of an additional data carrier in the reproducing equipment (device) is performed in such a manner that the additionally encrypted informative part of information is decrypted by the individual keys of the user's equipment and by the algorithm for additional decryption.

Restoration of the initial information in the reproducing device by performing the operation of the main decoding at the interaction of the accessory part of information recorded on a primary carrier and of the informative part restored in the reproducing equipment.

The system for recording information on carriers comprising data encoding unit and a unit for recording on a carrier of one part of the encrypted information, and a unit for additional transformation of the second part of information. System further comprises an additional device for recording additionally decrypted information on a separate carrier.

The system for recording can additionally comprise a unit for individualization of a reproducing device in the form of a device for additional encoding of the second part of the encrypted information.

The system for reproducing the encrypted information recorded on a carrier comprises a readout unit, a decoding unit and a unit for transformation of the encrypted information into a perceived shape.

The system further comprises a unit for individualization of a reproducing device and a unit for decoding of the accessory information.

A recording system and a reproducing system can use a smart card or another re-recorded carrier as an additional carrier for the accessory information (Smart card). Preferably, such carrier also should have a built-in processor for additional encoding as well as a recorded encoding algorithm and individual keys. Thus, the individual keys are accessories a reproducing unit.

### BRIEF DESCRIPTION OF THE DRAWINGS

FIG. 1 is a schematic diagram of a method for recording information, distribution and reproducing thereof.

FIG. 2 shows a schematic diagram of a system for recording and distributing information recorded on data carriers with the use of a main encoding and an additional encoding.

FIG. 3 shows a schematic diagram of a unit for reproducing information recorded on data carriers with the use of an additional decoding and a main decoding.

### EMBODIMENTS OF INVENTION

The claimed method is best illustrated by an example of manufacturing and sale of compact disks with their consequent reproducing on a specially equipped player.

Protection from unauthorized duplicating has always been a challenge for the mass and cheap production of compact disks. Generally, compact disks are duplicated at a factory by pressing plastic disks according to a die with the recorded information. Nowadays it is rather easy physically to copy any disk and to produce on its basis any number of copies.

According to the proposed method, the information subject to copying is most effectively is encrypted by the method disclosed in the PCT application (MV2)[WO 00/65767]. During the process of such encoding a preset number of encoding cycles is carried out as a result of each of which the encrypted information is compressed.

In this process results in forming in every cycle an accessory information bearing data about transformation within the cycle, but as a matter of fact having no connections with the initial information. The number of such cycles can be derived from the criterion of forming an encrypted text of a definite size (file length).

Thus, the accessory part of information is magnified with each cycle. In accordance with this method it is preferable, that the informative part was enough short, for example 1 Kilobyte. The accessory information can have the size comparable with the size of the initial file and it is recorded on a compact disk and then multiplicated. In this case unauthorized duplicating becomes inept and decoding is impossible, whereas the accessory part of information recorded on the carrier is not associated with the initial information. The short informative part should be additionally encoded and delivered to shops together with compact disks.

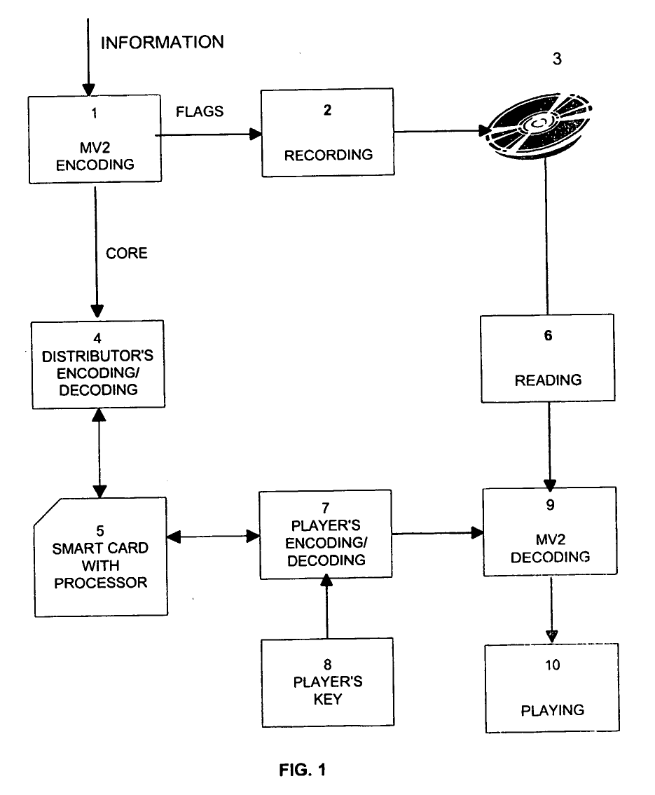

According to the claimed invention and FIG. 1, the initial information (audio, video or data) represented in a digital form is subjected to encoding in the unit 1 in accordance with the algorithm, which results in forming two files—CORE and FLAGS.

The accessory information is delivered to the recordal unit 2 to be recorded on the compact disk 3. Thereafter, the disks can be multiplied and distributed through shops and distributors' network.

In this case the core is additionally encoded in the unit 4 by the individual keys of the distributors who decode the core during recordal thereof on the smart-card having the customer's processor 5 at the moment of sale a license allowing to reproduce the information recorded on the carrier 3 on the individual reading device 6. The smart-card processor in this case re-encodes the core by the individual key of the reproducing device (player)

The individual player has the encoding device 7 with the individual key generator 8. To realize the said method and the system based thereon, each reproducing device is further provided with decoding unit 9 for restoring the initial information from the accessory information recorded on disk 3 and from the decoded core recorded on the smart-card. Thereafter, information restored in the unit 9 is delivered to a conventional player 10.

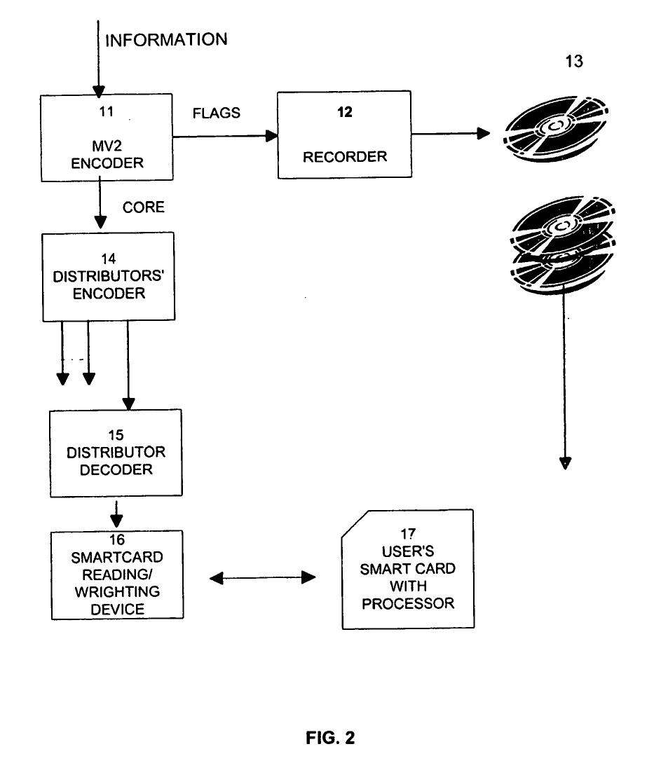

FIG. 2 shows the device for recording and distribution of recorded information in detail. The recording device comprises an encoding unit 11, to the input of which the initial information is supplied, such as an audio signal in a digital code. On the outputs of the encoding device 11 two encoded sequences are formed—the essential part CORE of about 1 kilobyte size and the accessory part FLAGS having the size comparable to the size of the initial information. The accessory part FLAGS is then supplied to the input of the recording device 12 to be recorded on the carrier 13 (a compact disk or a DVD disk), which is further multiplied in a regular manner and is delivered to distributors.

The short CORE (the essential part) is encoded in the encoder 14 by individual keys of distributors and is supplied to them respectively. Thus, the compact disks with the recorded accessory information can be distributed as freeware. As they have low cost price there is no sense for any unauthorized use. In fact, the essential thing is a license for reproducing, which is sold in the form of an individual code for the essential part of information.

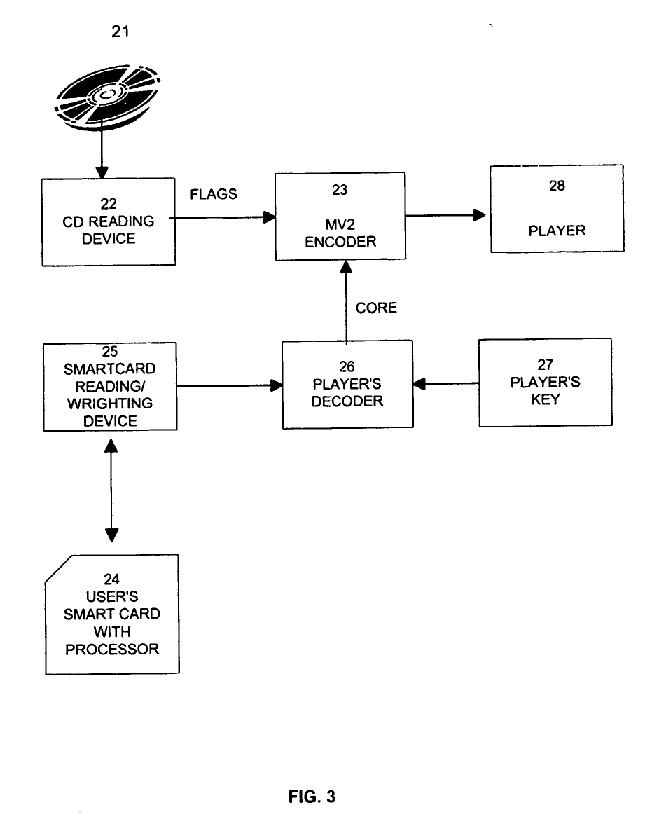

For that purpose, each distributor or a seller is provided with a special device comprising the decoder 15 for individual distributor code and a reading/recording device 16 for smart-cards of the consumer 17 with a processor for encoding the core by the individual code of the consumer player. FIG. 3 shows the player organization.

According to the invention the player for compact disks 21 as illustrated in FIG. 3 has a reading device 22 for compact disks, and the decoding device 23 connected thereto.

The player must have additional facilities for reading smart cards 24. This is realized by providing an additional device for reading/recording smart-cards 25 connected to the encoding/decoding device 26 for individual codes of the player, which codes are stored or generated in the device 27 for storing/generating keys.

The encoding device 26 relays the individual code to the recording device 25 for the smart-card 24, which comprises a processor with the algorithm for encoding the core.

Upon receipt of the core from a distributor for a certain charge, the core is automatically encoded by the individual key of the player and is stored in the memory of the card 24.

At reading in the player 25 the encoded core arrives at the decoding device 26 to be restored for further decoding of the initial information in the decoding device 23 by means of the accessory information recorded on the compact disk 21. The thus restored initial information arrives at the reproducing device 28.

Hence, for reproducing it is necessary to have both parts of the encrypted information and the encrypting algorithm. In this case the coding algorithm also can also be recorded on a primary carrier with the accessory information, since it has no connection with the initial information either.

On the other hand the players of customers should be equipped with special additional units capable of recording on a re-recorded carrier, for example a smart card. It is preferable, that such a carrier had a built-in processor for performing encoding by an individual key.

Buying a disk encrypted according to the described method, the customer additionally acquires a key for decrypting, i.e. the informative part of information, which should be protected by encrypting thereof on a smart card. The method requires that the key for additional encoding was an individual key stored in a reproducing device and on the additional carrier. The algorithm MZ4 [WO 00/56004] can be used as a reliable algorithm for such encoding.

At reproducing a disk on the special device the user inserts into it a disk and a smart card. In this case the informative part of information is decrypted and thereafter the initial information is restored with the help of its accessory part, which is recorded on the disk.

Thus, the method provides full protection from unauthorized duplication, which makes no sense in this case. The additional encoding of the informative part by an individual key makes impossible any decoding thereof, since the information has no meaning, and the initial information can be reproduced only on a special reproducing having an individual key.

1. The method for recording of initial information with protection against copying comprising encrypting information and recording the encrypted information on a carrier, characterized in that:
main encrypting information in such a manner, as a result of which two independent parts of information are formed: an informative part and an accessory part, each of which separately can not reproduce the initial information even in its separate parts;
recording an accessory part of information and the keys of the main encoding on a primary data carrier;
distributing the primary data carrier to any user;
additional encrypting the informative part by individual keys of the user recorded on an additional carrier; the said carrier being a processor, in which the algorithm of encoding with individual keys of the user is implemented,
recording of the additionally encrypted informative part of information on a said additional (secondary, supplemental) carrier, which interacts with the reproducing equipment for the initial information, and which after completion of the encoding has at his output the informative part encrypted by the individual keys of the user.

2. A method according to claim 1, characterized in that the main encoding is performed in such a manner that the size of the informative part of information is made substantially smaller than the size of the accessory part.

3. A method for restoring information for the sake of reproduction, comprising
interaction of the additional data carrier in the reproducing device in such a manner that the informative part of information is additionally decrypted by means of individual keys of the user and the algorithm of additional decryption.
Restoring in the reproducing device of the initial information by performing the process of the main decoding at interaction of the accessory information recorded on the primary carrier and the informative part restored in the reproducing device.

4. A system for recording information on carriers comprising a data encrypting unit, a unit for recording of the encrypted information on a carrier, a unit for additional transformation of the accessory information, characterized in that the system further comprises an encoding device and a device for recording the accessory information on the additional carrier and a unit for individualization of a reproducing device.

5. A system for reproducing encrypted information recorded on carriers comprising a readout unit, a unit for decrypting of the accessory information; the unit for individualization being further connected to a unit for reading-recording to the additional carrier.

6. A system for recording and a system for reproducing according to claims 4 and 5, characterized in that a smart card is used as an additional carrier for accessory information.

7. A system for recording, distributing and reproducing information recorded on carriers, comprising a data encrypting unit, a unit for recording of the encrypted information on a carrier and a readout unit, characterized in that the system further comprises a unit for additional transformation of the core information and a device for recording the core information on the additional carrier and a unit for individualization of a reproducing device, and a readout unit, additionally includes a unit for decrypting of the core information; the unit for individualization being further connected to a unit for reading-recording to the additional carrier.
